(19) United States
(12) Patent Application Publication
(10) Pub. No.: US 2026/0233352 A1
(43) Pub. Date: Aug. 13, 2026

(54) Machine for Machining of Optical Workpieces made of Plastic, in Particular Spectacle Lenses

(71) Applicant: Satisloh AG, Baar (CH)

(72) Inventors: Holger Schäfer, Weilmünster (DE); Johannes Claar, Ebsdorfergrund (DE); Martin Lautz, Nauborn (DE)

(21) Appl. No.: 19/532,258

(22) Filed: Feb. 6, 2026

(30) Foreign Application Priority Data
Feb. 7, 2025 (DE) 10 2025 104 657.3

(51) Int. Cl. B24B 13/00; B24B 13/005; B24B 55/06; B24B 57/02

(52) U.S. Cl. CPC B24B 13/0037; B24B 13/0055; B24B 55/06; B24B 57/02

(57) ABSTRACT

A machine for machining, in particular, spectacle lenses made of plastic, having two workpiece surfaces and a workpiece edge therebetween, comprises a first machining station for machining a spectacle lens at the workpiece edge by a first tool, a second machining station for wet machining of the spectacle lens on one of the workpiece surfaces by a second tool, and a movement device arranged functionally between the machining stations for positioning a workpiece holding head at the respective machining station, which movement device is capable of holding the workpiece without a block piece. Here, the machining stations have first and second work spaces which are separate from one another and are each encapsulated with respect to the surroundings. The first machining station furthermore has a housing which specifically delimits the first work space, and is adapted for substantially dry machining of the workpiece at the workpiece edge.

### TECHNICAL FIELD

The present invention relates generally to a machine for machining optical workpieces made of plastic, each of which has two workpiece surfaces and one workpiece edge therebetween. In particular, the invention relates to a machine for machining spectacle lenses made of plastic, such as polycarbonate, CR39 or so-called "high index" materials. Such spectacle lenses are produced to a very large extent in so-called "RX workshops", i.e. production shops for the production of individual spectacle lenses according to the prescription.

By way of example, the machine described herein is very suitable for use in combination with or in methods for machining spectacle lenses which do not use what are known as "block pieces" for securing the spectacle lenses during machining, as described in the documents WO 2023/046937 A1, WO 2023/073249 A1 and WO 2023/110939 A1, and/or for use with a workpiece receptacle, as is the subject matter of documents WO 2023/066824 A1, EP 4 454 810 A1 and EP 4 450 220 A1, and/or with a workpiece holding head, as is likewise disclosed in the document WO 2023/073249 A1. Here, the machine described herein develops, in particular, the combined CNC milling lathes which are disclosed in the documents WO 2023/066824 A1 and WO 2023/073249 A1, from which the features of the preamble of claim 1 are known in each case. With regard to the method and apparatus details in question here, reference is first of all expressly made here to the relevant explanations in the above-mentioned documents.

### BACKGROUND PRIOR ART

The above-mentioned document WO 2023/046937 A1 already describes in detail what process steps are conventionally carried out in RX workshops in the industrial production of spectacle lenses, such that the customary procedure is intended to be outlined only briefly at this point. The starting product in the industrial production of spectacle lenses is a semi-finished spectacle lens blank, also called a "blank", which has an optically effective surface which has already been finally machined, is prepared by injection molding or preformed in some other way, and is to be machined at its other optically effective surface and the edge between the optically effective surfaces to form a finished spectacle lens.

After the preformed optically effective surface has been protected by a protective film or a protective lacquer, the so-called "blocking" of the respective spectacle lens blank takes place, which is connected here to a suitable "block piece", for example a block piece according to the German standard DIN 58766. During blocking, the position and, if appropriate, the shape of the spectacle lens blank are first of all determined by measuring technology before the spectacle lens blank is then positioned in six degrees of freedom relative to the block piece, such that the block piece assumes a predefined position with respect to the protected, preformed surface of the spectacle lens blank. This set position is subsequently fixed by filling the space between the block piece and the spectacle lens blank with a conventional molten material ("alloy" or wax, see for example document EP 1 593 458 A2) or alternatively by a suitable thermoplastic, thermosetting or elastomeric plastic or adhesive (see, for example, documents DE 10 2007 007 161 A1, EP 2 011 604 A1, WO 2009/135689 A1). After the filling material has solidified or cured, the block piece constitutes a receptacle or machine interface for machining the spectacle lens blank, which receptacle or machine interface subsequently remains on the spectacle lens during a plurality of machining operations in different machines in order to be able to drive this spectacle lens in a rotating manner and to keep it reliably in an always defined position.

In the next step, the so-called "generating", the optically effective surface of the respective spectacle lens blank that has not yet been machined receives, in a special machine tool, also called a "generator" (see, for example, documents EP 1 719 585 A2 and EP 2 011 603 A1), by (pre)machining – in the case of plastic as a rule milling and/or turning with a geometrically defined cutting edge – their macrogeometry, i.e. the optically active shape according to the prescription. Here, the blocked spectacle lens blank is held by the block piece on a rotationally driven workpiece spindle. The generating as a rule comprises at least two sub-steps (see, for example, document EP 1 203 626 B1), namely edge pre-machining, also referred to as pre-edging or "cribbing", in which the edge of the spectacle lens blank is machined from the so-called "raw diameter" to the so-called "finished diameter” – for example by a disc-type milling cutter in the case of plastic (cf. for example document EP 0 758 571 B1) – and subsequent surface machining. In the case of plastic, the latter operation can begin with (at least) one milling operation over the surface, after which the main quantity of the blank material to be removed has already been removed, followed in most cases by "non-round" turning machining with the aid of a so-called "fast-tool" arrangement (see, for example, document EP 1 779 967 A2) for the reciprocal drive of a diamond turning cutting edge, in order (also) to machine non-rotationally symmetrical surface sections - for example free-form surfaces in the case of progressive spectacles – on the semi-finished product. A prerequisite for the aforementioned edge pre-machining by a milling cutter is that the block piece temporarily attached to the front side of the spectacle lens blank has a maximum diameter smaller than the finished diameter of the workpiece, since otherwise a collision between the milling tool and the block piece would occur.

This is followed by the (micro) fine machining of the spectacle lenses, generally referred to as "polishing", in which the pre-machined optically effective surface of the respective semi-finished product receives the desired microgeometry (surface quality), specifically by a geometrically undefined cutting edge. For this purpose, the pre-machined, blocked semi-finished product is removed from the generator and further machined in a precision machine tool or polishing machine (see, for example, document EP 2 308 644 A2). Here, the semi-finished product is likewise positioned and fixed in the polishing machine by the block piece (see, for example, document EP 1 473 116 A1). During polishing, with addition of a liquid polishing agent provided with abrasive particles, a flexible polishing tool or plate (see, for example, documents EP 1 698 432 A2 and WO 2016/058661 A1) is moved over the pre-machined surface in defined paths in order to reduce the surface roughness.

The semi-finished product is marked as an optional process step, wherein, for example, two small circles are produced on the rear-side surface of the semi-finished product by a laser beam or mechanically by an engraving stylus (see, for example, document EP 1 916 060 B1). This is necessary, for example, in the case of free-form surfaces in order to reliably find the position of the semi-finished product in later process steps via the introduced markings. Since a high degree of accuracy in the positioning is required here, the semi-finished product is also positioned and fixed by the block piece during marking.

Only after this machining is the semi-finished product separated from the block piece. The so-called "blocking" is effected, for example, in the case of the aforementioned adhesive bond by a high-pressure water jet emitted by a nozzle, which impinges on an edge point between the block piece and the semi-finished product, in order to detach the semi-finished product from the block piece by applying hydraulic forces (see, for example, documents WO 2011/042091 A1 and WO 2011/107227 A1). As a result, the machined semi-finished product is now present separately, and the separated block piece is cleaned and recycled to the process step of blocking.

In the further processing, the semi-finished product, after cleaning, is optionally coated on its front side and/or rear side in order to achieve additional effects – increasing the scratch resistance by hard coating, anti-reflection properties, color, mirror coating, hydrophobic properties, etc.

Finally, what is known as "edging" is carried out as a final process step, in which the semi-finished product is machined again at the edge for fitting into a desired spectacle frame, such that it obtains the shape of the respective spectacle frame. Since the semi-finished product is now no longer fixed on the block piece, the position has to be determined again here (for example on the basis of the above-mentioned marks), before the semi-finished product can be suitably fixed and finally machined in a so-called "edger" as an edge machining device (see for example document EP 1 243 380 A2) with regard to its edge shape and fastening in the spectacle frame.

The process chain outlined in this respect from the prior art includes, with the steps "blocking" and "de-blocking", two sequences which represent necessary auxiliary processes but do not themselves increase the value of the spectacle lens produced. What would therefore be desirable would be a process chain which manages without these auxiliary processes and consequently permits "block-free" machining of the workpieces, that is to say workpiece machining without the use of block pieces – to be applied specifically beforehand to the workpiece and then to be removed again from the workpiece – for holding the workpieces during machining.

For this purpose, in particular, document WO 2023/046937 A1 mentioned at the outset proposes a method for machining optical workpieces, in particular spectacle lenses made of plastic, in which method, proceeding from a blank, a semi-finished product is formed having predetermined surface geometries on a front side and a rear side facing away therefrom and having a contoured edge of predetermined edge thickness between the front side and the rear side. The method proposed therein comprises the following main steps running in the specified sequence: i) providing the blank which has a blank thickness, can already have the predetermined surface geometry on the front side, and is to be machined at least on the rear side and at the edge; ii) receiving the blank in a block-free manner on the rear side for the supported holding of the workpiece; iii) machining the blank on the front side by a first tool in order to form a circumferential groove or step with a depth which is greater than or equal to the edge thickness of the semi-finished product to be formed and less than the blank thickness, or of a circumferential recess which at least partially has a depth equal to the blank thickness, such that a circumferential surface which defines the contoured edge of the semi-finished product to be formed remains on the workpiece; iv) receiving the workpiece on the front side for the supported holding of the workpiece; and v) machining the workpiece on the rear side by at least one second tool in order to form the semi-finished product with the predetermined surface geometry on the rear side.

By virtue of the fact that, in the main step iii), the groove, the step or the recess is formed peripherally on the front side of the blank with, in each case, a depth which is greater than (equal to) the edge thickness of the semi-finished product to be formed, this occurs at the latest in the main step v), if the predetermined surface geometry of the semi-finished product is generated in a cutting manner on the rear side, for a complete separation of the semi-finished product from the excess, radially outer material of the blank. As a result of the depth extent of the groove, the step or the recess in the thickness direction of the workpiece, a circumferential surface, which defines the contoured edge of the semi-finished product to be formed, already remains here on the workpiece in the main step iii).

In other words, in the main step iii) of the proposed method, machining of the contoured edge of the semi-finished product to be formed – whether in the sense of a cribbed edge or a finished edge of the workpiece – is moved forwards or temporally advanced, specifically, proceeding from the front side of the blank received in a block-free manner on the rear side in the main step ii), before the workpiece, after being received on its front side, is surface-machined on its rear side in the main step iv) according to the main step v). In any case after the main step v), the generated semi-finished product is then completely separated from the excess, radially outer blank material, which falls off as a ring piece or as waste piece(s) in ring segments.

This basically two-stage procedure – first workpiece holder on the rear side and machining on the front side of the workpiece near the blank edge, thereafter receiving on the front side and machining on the rear side of the workpiece, even in the center – with the claimed sequence of the individual method steps affords significant advantages in the machining of, in particular, spectacle lenses made of plastic. These advantages relate primarily to the reliable holding of the workpiece during the actual edge (pre-)machining, which is important for process safety, and to the full-area underpinning or support of the workpiece during the actual surface machining, which underpinning or support is relevant for the machining quality, as described in detail in document WO 2023/046937 A1.

Combined CNC milling lathes, which are suitable for carrying out the above-described, block-free "edge-before-surface" production method for optical workpieces made of plastic, in particular spectacle lenses, are disclosed in documents WO 2023/066824 A1 (FIGS. 1 to 4) and WO 2023/073249 A1 (FIGS. 1 and 2) already mentioned at the outset. In general terms, these machines comprise a first machining station which is designed for machining a workpiece for shaping the workpiece edge by at least one first tool with a geometrically defined cutting edge, a second machining station which is designed for wet machining of the workpiece for shaping at least one of the workpiece surfaces by at least one second tool with a geometrically determined cutting edge while supplying a cooling lubricating liquid, and a movement device, functionally arranged between the first machining station and the second machining station, for positioning a workpiece holding head at the respective first or second machining station, which movement device is adapted to hold the workpiece without blocks, i.e. without using a block piece attached to the workpiece.

While the first above-mentioned document WO 2023/066824 A1 primarily deals with how, in this production environment, a receptacle for the machining of the workpiece can be configured in detail at the second machining station of the machine, a core concept of the second above-mentioned document WO 2023/073249 A1 is to specify possible details of a workpiece holding head which is particularly suitable for this production environment and which is provided on the movement device between the first machining station and the second machining station of the machine. In both cases, the first machining station comprises a milling spindle with an end mill, which is mounted in the region of a work space accommodating the second machining station on an upper side of a machine frame common to both machining stations. Furthermore, in both cases, a 6-axis articulated arm robot is flange-connected to the upper side of the machine frame as a movement device, which robot carries the workpiece holding head at its free end and serves specifically for holding and positioning the workpiece on the milling spindle of the first machining station and for workpiece loading of the receptacle in the second machining station.

It would be desirable to further optimize this basically proven machine concept with regard to process reliability with the highest possible workpiece throughput and with particular consideration of the fact that, in the case of edge and surface machining, a relatively large volume of different chips or waste pieces arises overall, which is to be disposed of in a skillful manner.

### SUMMARY OF THE INVENTION

In comparison with the prior art described in this respect, what is desired by the present invention is providing an alternative machine for machining optical workpieces made of plastic, specifically spectacle lenses, each having two workpiece surfaces and one workpiece edge therebetween, which is optimized with regard to process reliability with the highest possible workpiece throughput and in which the waste products arising during the edge and surface machining can also be disposed of as efficiently and satisfactorily as possible.

This desire is achieved by a machine for machining optical workpieces made of plastic, in particular spectacle lenses, which each have two workpiece surfaces and a workpiece edge therebetween. Advantageous or expedient refinements and developments of the invention are the subject matter of the dependent claims.

In a machine for machining optical workpieces made of plastic, in particular spectacle lenses, which each have two workpiece surfaces and a workpiece edge therebetween, comprising at least one first machining station which is configured for machining a workpiece for shaping the workpiece edge by at least one first tool with a geometrically defined cutting edge, at least one second machining station which is designed for wet machining of the workpiece for shaping at least one of the workpiece surfaces by at least one second tool with a geometrically defined cutting edge while supplying a cooling lubricating liquid, and a movement device arranged functionally between the at least one first machining station and the at least one second machining station for positioning a workpiece holding head at the respective first or second machining station, which movement device is adapted to hold the workpiece without a block piece; according to the invention, the first and second machining stations of the machine have first and second work spaces which are separate from one another and are each encapsulated with respect to the surroundings, wherein the first machining station has a housing, which specifically delimits the first work space, and is adapted for substantially dry machining of the workpiece at the workpiece edge.

When reference is made in connection with the present invention to "substantially dry" machining of the workpiece in the first work space of the first machining station, this should be understood to mean both classic dry machining, which entirely dispenses with a liquid during the machining, and also so-called "minimum quantity lubrication" (MMS) or "minimum quantity cooling lubrication" (MMKS), in which a small quantity of a cooling lubricant is used during the machining process (by definition less than 50 ml of cooling lubricant per hour). For such a lubrication, a liquid-gas mixture (primarily compressed air with oil fill) is used, for example, in spray systems, which liquid-gas mixture is conducted as cooling lubricant, for example via a nozzle, in a process-safe metered manner, to the first tool. As a result of the optimum quantity of cooling lubricant at the correct location, the generation of frictional heat is prevented or at least greatly reduced. Any remaining residual heat is dissipated via the first tool and the chip.

Finally, in the course of the "substantially dry" machining of the workpiece edge provided according to the invention, no appreciable moisture arises even when MMS or MMKS is used in the first work space of the first machining station and on the chips produced there, which moisture would intensify or just bring about adhesion of the chips to the housing or accumulation of the chips on one another.

The "wet" machining of the workpiece surface, which takes place in the second machining station with the supply of a cooling lubricating liquid, contrasts with this, in which the second tool in the second work space is properly flooded with the cooling lubricating liquid. Such wet machining is conventionally based on circulation and requires an outflow connector at the second work space of the second machining station, via which outflow connector the chips that are produced are flushed out of the second work space with the cooling lubricating liquid before the cooling lubricating liquid can be treated.

By virtue of the fact that the first machining station has the first work space in its own housing and the second machining station has the second work space separated therefrom, wherein both work spaces are each encapsulated with respect to the surroundings, the edge machining and the surface machining can first be carried out in parallel or at the same time on different optical workpieces, and without disrupting one another, which is advantageous with regard to the efficiency of the machine.

In addition, there is no risk that, as a result of wet machining in the second machining station, contamination of the dry first machining station occurs, the housing of which is also easy to clean.

In relation to a workpiece, the respective machining of the edge or surface of the workpiece is carried out in each case separately first in a substantially dry environment and only then in a wet environment. Accordingly, after the edge machining in the first machining station, the workpiece can be moved in a dry state out of the first machining station with the workpiece holding head. Firstly, this has the advantage that, during the transport of the workpiece held without blocks on the workpiece holding head from the first machining station to the second machining station, the risk of the workpiece slipping on or even slipping off from the workpiece holding head is minimized. Consequently, the transport itself can also take place in a time-optimized manner.

Secondly, drying and cleaning of the workpiece – and the associated non-value-adding effort – are advantageously dispensable before the workpiece is transferred from the workpiece holding head to or into the second machining station, because it does not have to be expected that, after the substantially dry edge machining in the first machining station, machining residues adhere or "stick" to the workpiece on account of residual moisture. Accordingly, the workpiece can also be received quickly and in a process-safe manner in the second machining station.

In one preferred refinement of the machine, the housing of the first machining station is covered, on a side lying opposite the first tool, by way of a work space cover, by which the first work space can be separated from the surroundings. Such a work space cover could possibly also be omitted, for example if the dry chips produced in the machining station were extracted at the housing of the first machining station with a relatively high suction power. By contrast, however, the provision of a work space cover is more favorable with regard to high energy efficiency and low noise generation. In addition, this type of encapsulation affords advantages with regard to occupational safety and servicing/maintenance of the machine, since at most very small amounts of fine dusts can escape from the first work space.

This work space cover on the housing of the first machining station is preferably variable and, for coupling the workpiece holding head, has an interface which can be moved with respect to the first work space and has an open coupling part, through which a workpiece held on the workpiece holding head can be introduced into the first work space, in order to come into machining engagement with the first tool. Here, "variable" means that the work space cover is adapted to follow the movement of the interface and nevertheless to separate the first work space from the surroundings. Instead of a movable interface on the variable work space cover, the housing of the first machining station could of course also move away with the first tool under the work space cover. However, such a configuration would be far more complex because a further kinematics system would be required, and is therefore less preferred.

As far as the movement possibilities or degrees of freedom of the interface for the workpiece holding head on the variable work space cover are concerned, it is furthermore preferred if the coupling part of the interface is arranged so as to be movable with respect to the first work space in a plane formed on the variable work space cover by a first direction and a second direction running transversely thereto, as well as in a third direction running transversely to this plane. Accordingly, the coupling part of the interface preferably allows a spatial movement of the workpiece holding head docked thereon with respect to the housing of the first machining station, which coupling part in this case remains sealed off from the surroundings by the variable work space cover. Alternatively, a division of the movements necessary for the machining of the workpiece to the workpiece and the tool would also be conceivable, for example a merely planar movement possibility of the coupling part of the interface with the workpiece holding head docked thereon in the first and second directions with respect to the housing of the first machining station plus a movement possibility of the first tool in the third direction in the housing of the first machining station. However, this would in turn require an additional kinematics system on the tool side and would therefore be more complex and less preferred.

The coupling part of the interface preferably has a conically shaped inner circumferential surface, while the workpiece holding head has a flange portion which, on the outer circumferential side, is of conical form complementary to the conically shaped inner circumferential surface of the coupling part, such that, when the workpiece holding head is coupled to the interface, self-centering advantageously takes place between the coupling part and the flange portion. It would of course also be possible to provide other geometries at the coupling point between the coupling part and the workpiece holding head, for example a conical surface only on one part, which interacts with a cylindrical surface on the other part. However, with regard to the best possible sealing at the coupling point and a problem-free entrainment of the coupling part during the movements of the workpiece holding head, the double-conical configuration of the coupling point should be preferred, because more contact surface is available for sealing and force transmission.

In a further embodiment of the interface described above, which is preferred in particular with regard to low complexity in terms of apparatus technology, the coupling part of this interface is guided by a guide arrangement during a movement in the third direction, wherein the coupling part is spring-preloaded in the third direction away from the first work space of the first machining station by a spring arrangement. Such a spring arrangement can comprise, for example, helical compression springs and/or air springs. On account of the spring arrangement, the coupling part guided on the guide arrangement thus follows a movement of the workpiece holding head in the third direction in a "passive" manner. As an alternative, this could possibly also be achieved by a correspondingly elastically resilient design of the variable work space cover in this region, which, however, would make the variable work space cover more rigid. Other measures would also be conceivable in order to maintain a connection between the coupling part of the work space cover and the workpiece holding head during its movements, for example a form-fitting connection (bayonet or the like) or a magnetic connection between the parts under discussion. However, these "active" connection types would require a higher complexity in terms of apparatus technology and/or a further (rotational) movement possibility of the workpiece holding head with respect to the coupling part, for which reason they are less preferred.

If the coupling part of the interface is optionally also guided in a tiltable manner on the guide arrangement with respect to the plane formed by the first and second directions, this advantageously allows tilting of the workpiece holding head with respect to the first tool in the first machining station, said tilting being sealed off by the variable work space cover, in order to produce, if appropriate, even prismatically set or tilted geometries at the workpiece edge.

In one preferred refinement of the machine, provision is furthermore made for the variable work space cover to have a fixing device for the coupling part of the interface, having at least one locking element which is selectively movable from a fixing position for the coupling part into a release position for the coupling part and vice versa, wherein the locking element is adapted, in its fixing position, to hold the coupling part in a defined parking position, in which the spring arrangement preloading the coupling part is compressed, and to be disengaged from the coupling part in its release position, such that the coupling part can be moved in a guided manner on the guide arrangement into working positions under preload by the spring arrangement. A main advantage of such an optional fixing device for the coupling part of the interface is that, if no machining of a workpiece takes place in the first machining station, the coupling part can be parked in the parking position predefined by the locking element and is thus located in one (numeral) spatially clearly defined position. If machining of a workpiece held on the workpiece holding head is then to be carried out in the first machining station of the machine, the workpiece holding head can be moved quickly and reliably by the movement device for docking to the coupling part of the interface. Otherwise, the respective position of the coupling part of the interface would, for example, have to be sensed complexly in order to ensure rapid approach and finding by the workpiece holding head. Ultimately, the fixing device is therefore conducive to a high efficiency of the machine with a low complexity in terms of apparatus technology.

One refinement of the machine is furthermore preferred, in particular with regard to a construction which is as favorable and compact as possible and is as easy as possible to move, in which refinement the variable work space cover has a bellows arrangement, comprising an outer frame fixedly connected to the housing of the first machining station, a middle frame which is slidably guided in the outer frame in the first direction and is connected to the outer frame on opposite sides in the first direction via in each case one flat bellows, and an inner frame which is slidably guided in the middle frame in the second direction, running transversely with respect to the first direction, and is connected to the middle frame via in each case one flat bellows on opposite sides in the second direction, wherein the inner frame is provided with an opening for the workpiece holding head to pass through into the first work space and carries the interface for the workpiece holding head. Possible alternatives for a variable work space cover comprise a bag-like or hose-like cover, roller blinds, slatted covers, telescopic plates or the like between the housing of the first machining station and the interface for the workpiece holding head, which, however, compared to the bellows arrangement, are less satisfactory compromises between satisfactory sealing of the first work space, highly smooth running during the movement of the interface, low wear and maintenance complexity with costs which are also as low as possible. For the variable covering of the first work space in the first and second directions, a shield travelling along with the interface would likewise be conceivable, which, in contrast to the preferred bellows arrangement, would necessitate a high structural or functional space requirement for the work space cover.

In one preferred development of the machine provided with the above bellows arrangement at the first machining station, the bellows arrangement has, furthermore, a substantially hollow-cylindrical bellows which is arranged between the coupling part of the interface and the inner frame in a manner which seals the first work space with respect to the surroundings. As alternatives to this, for example, telescopic sleeves or a rolling bellows are conceivable at this point, but are less preferred for the reasons specified above.

The housing of the first machining station preferably has at least one outflow connector, via which chips in particular can be extracted from the first work space. Such an outlet connector could in principle also be seated on the work space cover, but this would be associated with a higher connection complexity.

Furthermore, the housing of the first machining station preferably has at least one inlet connector, via which, in particular, ambient air can be passively sucked or actively supplied into the first work space. In this way, it is possible in a simple manner to reliably ensure that a flow is formed in the housing of the first machining station, which flow carries the chips arising during the machining away to an outlet of the first work space. However, an inlet connector on the housing can possibly also be dispensed with if sufficient air can reach the first work space at another point, for example as sealing air from a spindle driving the first tool and/or via corresponding passages at/in the work space cover. Finally, an inlet connector on the housing, which is provided, for example, with a throttle valve, can advantageously also enable influencing of the air flow in the first work space in a manner dependent on the material to be machined in the first machining station.

Preferably, the housing of the first machining station furthermore has at least one opening which is surrounded by a flange portion and through which a spindle of the first machining station, which spindle is flange-connected to the flange portion, projects into the first work space with a rotationally drivable tool holder for the first tool. Advantageously, this flange portion in the machine can thus serve for fastening the spindle to the housing of the first machining station or, conversely, for fastening the housing to the spindle of the first machining station.

In one preferred refinement of the machine, at least one nozzle for compressed air is attached to the housing of the first machining station, said nozzle being fixedly directed or variably directable onto the first tool for the substantially dry cutting shaping of the workpiece edge, in order to blow out and cool a cutting point between the workpiece and the first tool. Compared with a likewise possible refinement without nozzle/nozzles, the provision of at least one nozzle is advantageous with regard to efficient chip discharge. Advantageously, no chip deposits arise or chips cannot settle in generated geometries on the workpiece. As a result of the cooling, chips also do not tend to stick together. By such a nozzle, it is also advantageously possible for air to be emitted in pulsed form, if appropriate, in order to break chips at the cutting point.

Preferably, the housing of the first machining station is also designed to be optimized in terms of flow with regard to an unimpeded discharge of chips, without undercuts and without corners in the first work space. Maintenance and cleaning work at/in the first work space can thus advantageously be reduced, if not even eliminated.

The housing of the first machining station is, furthermore, preferably of smoothed form on its surfaces delimiting the first work space, for example by polishing or coating. As a result, chips do not adhere to or cannot become stuck to the housing wall. Moreover, this measure advantageously reduces the extraction resistance.

Finally, the housing of the first machining station is preferably injection-molded or produced by additive manufacturing, from a plastic with optionally electrically conductive, antistatic or statically dissipating properties. Compared to other possible materials and production methods (for example edging and welding or deep-drawing of metallic sheets, light metal die-casting), this is advantageous in particular with regard to the least possible production costs with at the same time a satisfactory possibility of a flow-optimized design of the housing. By using a plastic having the properties mentioned, it is also possible in a simple manner to prevent or at least reduce adhering of chips to the housing wall as a result of static charging.

In one expedient refinement, the machine can furthermore be equipped with a chip discharge device, to which one or preferably both of the first and second work spaces of the first and second machining stations is/are connected. If both work spaces are connected to a common chip discharge device, this advantageously reduces the complexity associated with the chip discharge.

With regard to the (substantially) dry part of the machining in the first machining station of the machine, the chip discharge device preferably comprises a suction system with a chip separator, which is connected to the housing of the first machining station in order to extract chips from the first work space. In principle, it would also be possible to blow the chips out of the housing of the first machining station by a fan. By contrast, a suction solution is, however, simpler to implement and more reliable in terms of process, in which, in particular, the delivery volume can be monitored satisfactorily. The latter also reduces the risk of fine dust in the environment and thus easily satisfies any possible occupational safety requirements. If the suction system is additionally equipped with a chip separator – in contrast to pure filter solutions, for instance – the suction system can operate very energy-efficiently. Filters which are nevertheless present in the suction system cannot become clogged as quickly, and maintenance intervals in this respect are also advantageously extended.

Furthermore, with regard to the wet part of the machining in the second machining station of the machine, in particular, the chip discharge device preferably comprises a collection container, into which chips can be flushed out with the cooling lubricating liquid via an outflow connector of the second work space. In contrast to a refinement of the machine without a collection container which is likewise conceivable in principle and in which, for example, the cooling lubricating liquid is conducted with the chips via a pipe system with a gradient to an external cooling lubricant preparation system, a significant advantage of the collection container integrated into the machine is that there is a high degree of flexibility in the selection of the machine erection space.

In particular with regard to the lowest possible complexity in terms of apparatus technology and installation space requirement, it is furthermore preferred if the chip separator of the (dry) suction system is connectable to the (wet) collection container, such that the chips from the substantially dry machining can be disposed of together with the chips from the wet machining. Here, the cooling lubricating liquid coming from the second machining station also advantageously "binds" the smallest particles coming from the first machining station via the chip separator of the suction system, such that no dust pollution of the environment can take place here.

With regard in turn to the (substantially) dry part of the machining in the machine, the chip separator of the suction system is preferably configured as a cyclone separator, having an upper part, into which a central immersion pipe which can be connected to a negative pressure source of the suction system opens and which is provided with a circumferential-side inlet connector connected to the first work space, having a conical lower part which adjoins the upper part and merges into an expansion chamber, and having a chip collector which closes off the expansion chamber in the downward direction. Such a chip separator advantageously operates in a very energy-efficient manner and in a relatively quiet manner with high degrees of separation and, moreover, is very low in maintenance. This also has an advantageous effect on the maintenance intervals of the actual suction system with its usually provided fine filters. Not least, filters with complex and loud vibration solutions and the maintenance and cleaning effort necessarily associated therewith can be entirely dispensed with there.

In particular with a view to once again the lowest possible maintenance and cleaning complexity, it is furthermore preferred if a shredder pump, the pump head of which is equipped with a cutting mechanism for shredding the chips, is arranged in the collection container of the chip discharge device. Large waste pieces (e.g. ring sections or ring segments), which can accumulate in the second machining station as a result of the above-described "edge-before-surface" machining and are flushed with the cooling lubricating liquid out of the second work space towards the collection container, can thus also be disposed of in a simple manner. In principle, as an alternative to the cutting mechanism on the pump, possible trapping solutions in or upstream of the collection container, such as, for example, rakes or perforated plates which serve to trap relatively large waste pieces, can thus advantageously be avoided, just like the associated cleaning and maintenance effort.

In one preferred development of the machine, the chip collector of the chip separator has a flap which can be selectively opened by a flap drive in order to empty the chip collector, wherein the flap is preferably sealed off from a lower outlet flange of the chip collector by a circumferential seal. Such a flap solution is advantageous over possible alternatives, such as a slide solution or a rotary valve, in particular with regard to a low complexity in terms of apparatus technology, and safe and reliable emptying of the chip collector when required. This is particularly because the risk of jamming is largely avoided. If the optional circumferential seal is provided here, false air or secondary air can at most enter or be drawn to a small extent into the chip separator, which could impair the degree of separation there or would require a stronger suction effect of the suction system for efficient operation of the chip separator.

In principle, the chip separator can be arranged, for example, above the collection container, such that the chips coming from the first work space can be emptied directly into the collection container. However, in contrast to such an arrangement, preference is given to one refinement of the machine, in which the chip collector of the chip separator can be emptied into an outflow pipe between the outflow connector of the second work space and the collection container of the chip discharge device. This advantageously leads to improved mixing of the chips from the first machining station with the contaminated cooling lubricating liquid from the second machining station on the way to the collection container and consequently to a more uniform introduction of all machining wastes into the collection container. In this case, in particular, a process-safe disposal of the processing wastes via the shredder pump can ultimately be accomplished more easily.

Preferably, furthermore, the shredder pump in the collection container can be connected to a conveying line for contaminated cooling lubricating liquid via a valve which can be switched in an automated manner. Such a refinement advantageously allows continuous operation of the shredder pump without the risk of pump-damaging dry running of the shredder pump. Here, deposits in the collection container are also largely avoided as a result of the constant fluid movement (secondary flow). In addition, the risk of starting difficulties of the shredder pump due to blockages of the cutting mechanism with, for example, particularly large waste pieces from the second machining station is advantageously averted.

As far as the concrete design of the movement device functionally inserted between the first machining station and the second machining station of the machine is concerned, there are different design possibilities. By way of example, a multi-axis robot can be used here, as is shown in the above-mentioned documents WO 2023/066824 A1 and WO 2023/073249 A1 which are hereby incorporated by reference. However, one refinement of the machine is preferred here in particular with regard to a particularly high rigidity and accuracy during the positioning movements – which would ultimately also be conducive to a high process reliability – in which refinement the movement device is adapted to move the workpiece holding head in at least three linear, mutually perpendicular axial directions in order to generate the feed and advancing movements required for edge machining in the first machining station, to make transport of the workpiece held on the workpiece holding head between the first machining station and the second machining station possible and, in the second machining station, to permit a positioned transfer of the workpiece.

In the case of a corresponding arrangement of the first and second machining stations with respect to one another, the above-mentioned three linear degrees of freedom of movement of the movement device for the workpiece holding head are in principle sufficient to fulfil the workpiece positioning and transport tasks in question at or between the first and second machining stations of the machine. Optionally, the movement device of the machine can finally be additionally adapted to pivot the workpiece holding head about at least one pivot axis which runs transversely to one of the axial directions mentioned. This additional pivot axis advantageously increases the variety of variants in the workpiece geometries that can be produced in the first machining station – by way of example, the possibility of producing prismatically tilted geometries in the first machining station can be mentioned – and also affords advantages in workpiece handling if it is necessary to receive the workpiece on the workpiece holding head or to release it from the workpiece holding head.

Further features, properties and advantages of the machine according to the invention emerge for a person skilled in the art from the following description of one preferred exemplary embodiment.

### BRIEF DESCRIPTION OF THE DRAWINGS

The invention will be explained in more detail below on the basis of one preferred exemplary embodiment with reference to the attached, partially simplified or schematic drawings. In the drawings:

FIG. 1 shows a perspective view of a machine according to the invention for machining optical workpieces made of plastic, specifically spectacle lenses, from obliquely above/rear left, with a view of a first machining station for predominantly dry machining of the workpieces, a second machining station for wet machining of the workpieces, a movement device with a workpiece holding head for positioning and transporting the workpieces therebetween, and a chip discharge device for both machining stations;

FIG. 2 shows a perspective view of the machine according to FIG. 1 from obliquely above/front right with a view of the second machining station and the movement device;

FIG. 3 shows an enlargement of the detail III in FIG. 1, which illustrates how the movement device of the machine positions the workpiece holding head with respect to a movable interface for coupling the workpiece holding head to a variable work space cover of the first machining station;

FIG. 4 shows an enlargement of the detail IV in FIG. 2 for further illustrating the construction of the movement device of the machine;

FIG. 5 shows an enlargement of the detail V in FIG. 2, with a view into the second machining station of the machine, in which a central workpiece spindle with a receptacle for holding the optical workpieces without blocks is arranged;

FIG. 6 shows a plan view of the machine according to FIG. 1;

FIG. 7 shows a sectional view of the machine according to FIG. 1 corresponding to the sectional profile line VII-VII in FIG. 6, for illustrating further details of the "wet" second work space of the second machining station, which second work space is connected via an outflow connector to an outflow pipe of a chip discharge device, into which a chip collector of a chip separator assigned to the first machining station can also be emptied via a flap, wherein the assemblies for wet machining of the workpiece in the second machining station are illustrated in unsectioned form in order to simplify the illustration;

FIG. 8 shows a sectional view, broken off towards all sides, of the machine according to FIG. 1 corresponding to the sectional profile line VIII-VIII in FIG. 6, with a view of the flap for emptying the chip collector;

FIG. 9 shows a perspective view, broken off to the right, of the machine according to FIG. 1 from the rear left, with a view of the chip discharge device of the machine and the connections thereof to the first and second work spaces, separated from one another, of the first and second machining stations, to a vacuum source and to a device for processing the cooling lubricating liquid contaminated with chips via a collection container of the chip discharge device, which is illustrated in cut-away form in order to clear the view of a shredder pump in the collection container;

FIG. 10 shows a perspective, downwardly cut-off view from obliquely above of the first machining station illustrated separately from the machine according to FIG. 1, with a view of the housing thereof which is specifically provided for delimiting the first work space and has a spindle flange-connected thereto from below for driving a first tool, a variable work space cover having a bellows arrangement on the housing, and a fixing device for the work space cover in a fixing position, wherein, in addition, a pivoting fork of the movement device can be seen, to which the workpiece holding head is attached, which, fitted with a workpiece, is inserted into the first work space in a coupling position;

FIG. 11 shows a perspective view, corresponding with regard to the manner of illustration and the viewing angle to FIG. 10, of the first machining station of the machine according to FIG. 1, in which the fixing device is situated in a release position;

FIG. 12 shows a sectional view, which is broken off towards the bottom in the region of the first work space, of the first machining station of the machine according to FIG. 1 corresponding to the sectional profile line XII–XII in FIG. 10;

FIG. 13 shows a perspective view of the first machining station of the machine according to FIG. 1, substantially corresponding with regard to the manner of illustration to FIGS. 10 and 11, from a different viewing angle, in which, in comparison with FIGS. 10 and 11, the fixing device and the bellows arrangement of the variable work space cover have been omitted, wherein the workpiece holding head is situated in a working position pivoted with respect to the pivoting fork;

FIG. 14 shows a perspective exploded illustration of the variable work space cover, shown isolated from the first machining station of the machine according to FIG. 1, with the bellows arrangement in the viewing angle of FIG. 13, which, as viewed from bottom to top along a base axis, shows an outer frame, a middle frame with flat bellows on both longitudinal sides, an inner frame with flat bellows on both transverse sides, a hollow-cylindrical bellows, a spring arrangement, a coupling part of the interface for the workpiece holding head, and a guide arrangement therefor;

FIG. 15 shows a plan view, rotated clockwise in the plane of the drawing, of the first machining station, shown in FIG. 13 without a fixing device and bellows arrangement, of the machine according to FIG. 1;

FIG. 16 shows a downwardly broken-off sectional view of the first machining station, shown in FIG. 13, of the machine according to FIG. 1 corresponding to the sectional profile line XVI-XVI in FIG. 15;

FIG. 17 shows a sectional view of the first machining station, shown in FIG. 13, of the machine according to FIG. 1 corresponding to the sectional profile line XVII-XVII in FIG. 16;

FIG. 18 shows a sectional view, on an enlarged scale and broken off towards all sides, of the first machining station, shown in FIG. 13, of the machine according to FIG. 1 corresponding to the sectional profile line XVIII-XVIII in FIG. 15, wherein the hollow-cylindrical bellows of the bellows arrangement is also shown in the undeformed state for orientation;

FIG. 19 shows a sectional view, on an enlarged scale and broken off towards all sides, of the first machining station, shown in FIG. 13, of the machine according to FIG. 1 corresponding to the sectional profile line XIX-XIX in FIG. 15, wherein the hollow-cylindrical bellows of the bellows arrangement is once again also shown in the undeformed state for orientation – just like a helical compression spring of the spring arrangement;

FIG. 20 shows a side view, on an enlarged scale, of the inner frame of the bellows arrangement, shown in FIG. 14, of the first machining station of the machine according to FIG. 1, with the coupling part of the interface for the workpiece holding head, said coupling part being preloaded by the spring arrangement and guided by the guide arrangement, wherein the coupling part is shown in a tilted working position in accordance with the illustration in FIG. 13; and

FIG. 21 shows a sectional view, broken off to the left and downwards, of the components of the variable work space cover shown in FIG. 20, corresponding to the sectional profile line XXI–XXI in FIG. 20.

With regard to the drawings, it should also be noted at this point that the illustration of the machine according to the invention is simplified in large parts. Thus, in the drawings, in order to clear the view of essential components or assemblies of the machine and in order to simplify the illustration, individual parts of the cladding, of the supply devices (including lines, hoses and pipes) for current, compressed air and the cooling lubricating liquid, and of the suction system and also the measuring, maintenance and safety devices are, in particular, also mostly omitted insofar as they do not appear necessary for understanding the invention.

### DETAILED DESCRIPTION OF THE PREFERRED EMBODIMENT

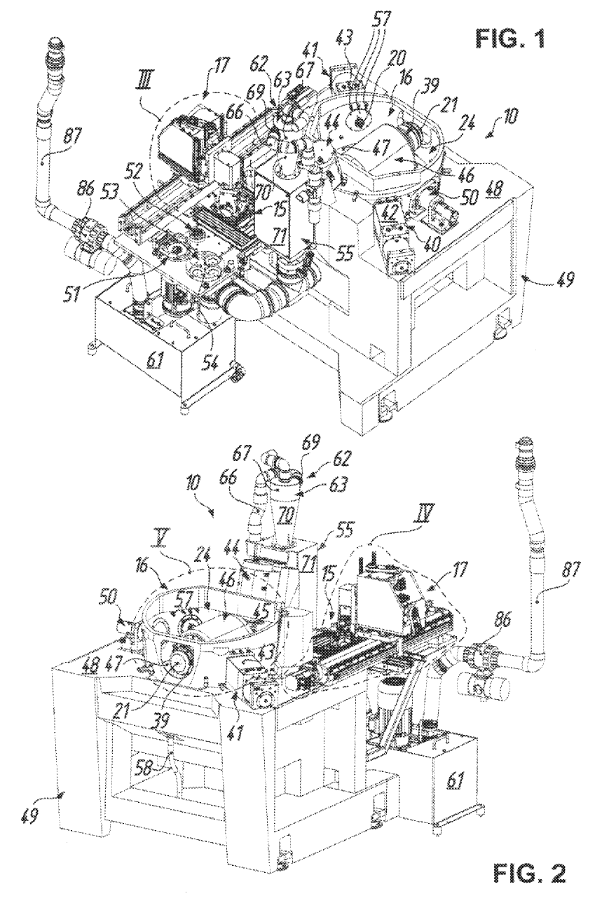

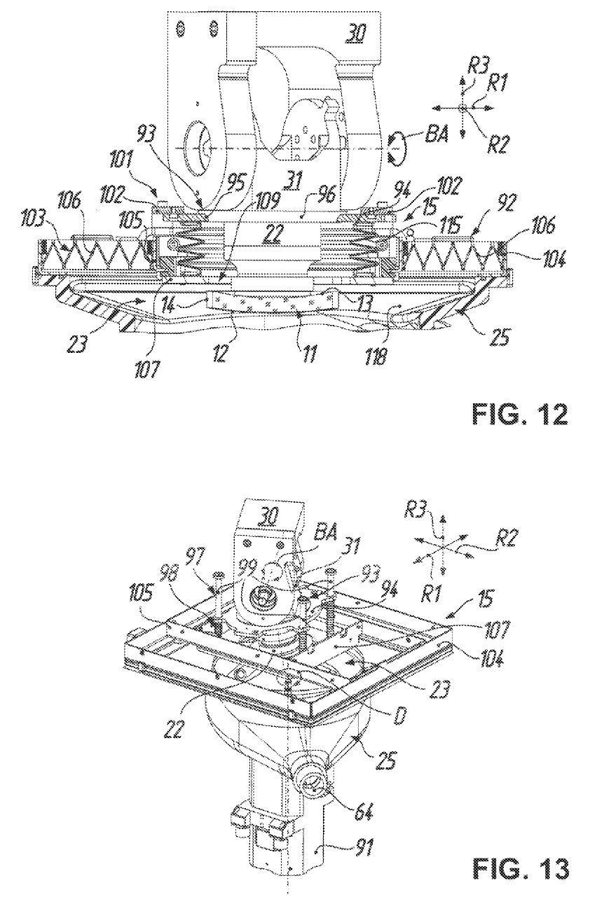

In FIGS. 1 to 9, a combined CNC miller/lathe (hereinafter referred to as machine for short) for machining, in particular, spectacle lenses made of plastic is generally denoted by the reference sign 10. A spectacle lens 11 as an example of an optical workpiece to be machined is shown in FIGS. 12 and 16.

The spectacle lens 11 has two workpiece surfaces – in any case optically effective at the end of the machining – which are referred to below as front side 12 (facing away from the eye) and rear side 13 (facing towards the eye) in accordance with their installation position in a spectacle frame, and a workpiece edge 14 therebetween. In the various machining states, that is to say proceeding from the spectacle lens blank via the partially machined spectacle lens semi-finished product as far as the finished spectacle lens – numbered here throughout with the reference sign 11 regardless of the respective machining state – it is always a planar workpiece. As such, the spectacle lens 11 must be reliably held during machining and handling, in particular insofar as external forces act on the spectacle lens 11 here, and at the same time must be supported against undesired deformations. For this purpose, special measures are taken in the case of the machine 10 described here, as will be explained below, which permit machining of the spectacle lens 11 on the workpiece edge 14 and on the rear side 13 without the block pieces conventionally used as a holder for this purpose and also without holding the spectacle lens 11 on the workpiece edge 14.

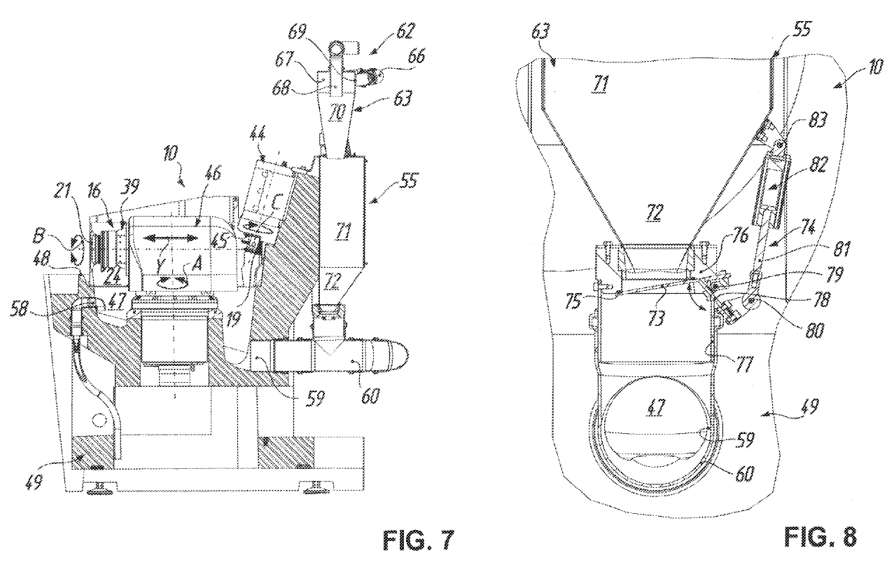

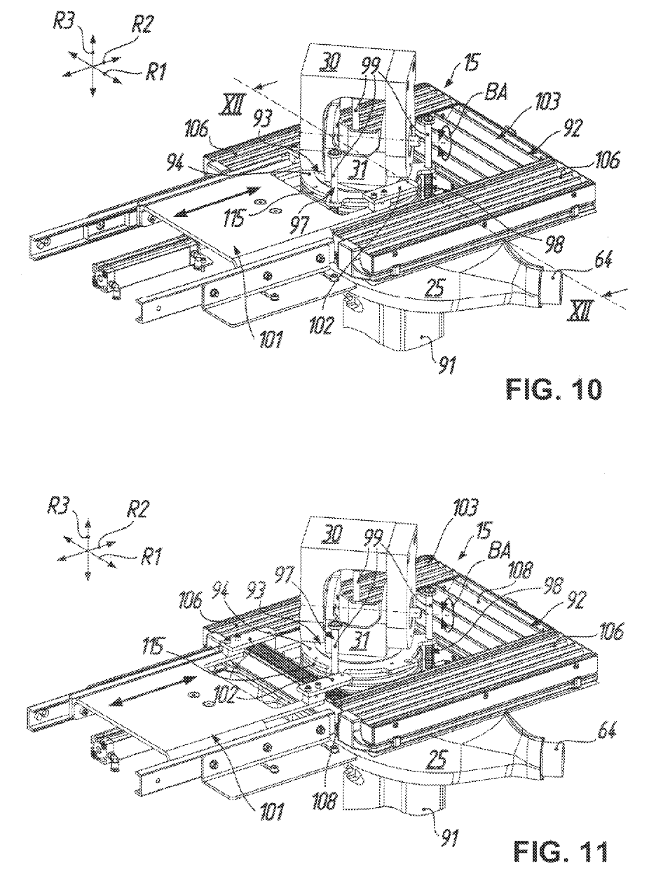

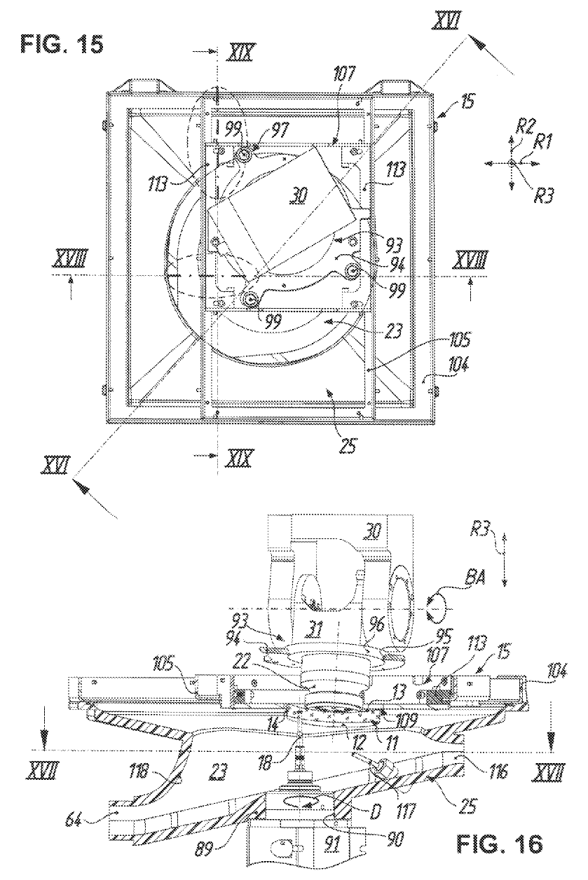

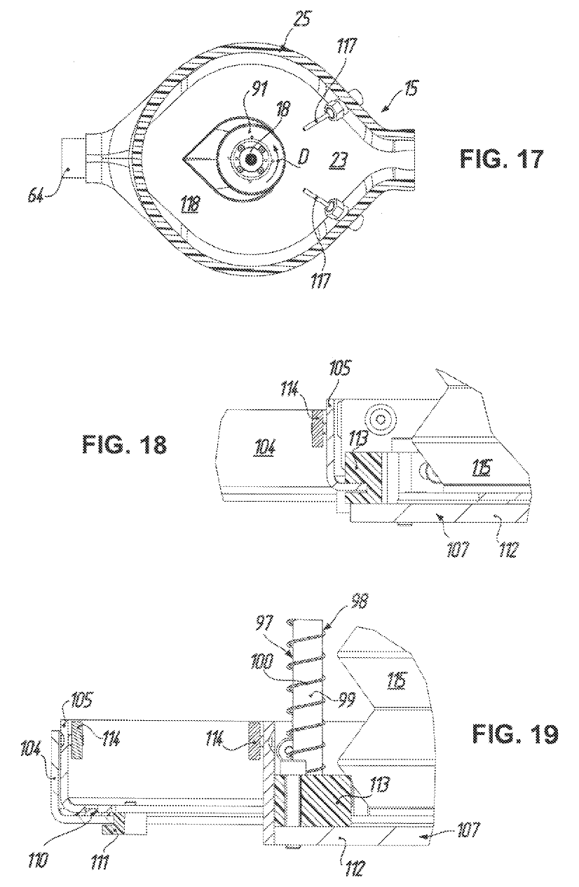

In general terms, the machine 10 comprises a first machining station 15, a second machining station 16 and a movement device 17, arranged functionally between the first machining station 15 and the second machining station 16, for the spectacle lens 11 to be processed in each case. While the first machining station 15, which is described in detail below in particular on the basis of FIGS. 10 to 21, is designed for machining the spectacle lens 11 for shaping the workpiece edge 14 by a first tool with a geometrically determined cutting edge (see the end mill 18 shown in FIGS. 16 and 17), the second machining station 16 is designed for wet machining of the spectacle lens 11 for shaping the rear side 13 by at least one second tool with a geometrically defined cutting edge (cf. the milling tool 19 illustrated in FIG. 7 and the turning tools 20 fitted in FIGS. 1 and 6) while supplying a cooling lubricating liquid.

Here, the second machining station 16 corresponds substantially to what is known as a "generator", as is available from Satisloh AG, Baar, Switzerland under the trade name "VFT-orbit" and is the subject matter of document EP 2 011 603 A1, to which reference is first expressly made here with regard to the construction and function of a generator. However, the second machining station 16 shown here differs therefrom in that the spectacle lens 11, without the aid of a block piece as a holder during the machining thereof in the second machining station 16, is held so as to be supported in a planar manner on a specific workpiece receptacle 21. Such a workpiece receptacle 21 is the subject matter of documents WO 2023/066824 A1 or EP 4 454 810 A1 and EP 4 450 220 A1 mentioned at the outset, to which reference is expressly made here with regard to the construction and function of the workpiece receptacle 21.

The movement device 17, functionally arranged between the first machining station 15 and the second machining station 16, serves in particular to position a workpiece holding head 22 (can be seen only in FIGS. 12, 13 and 16) at the respective first or second machining station 15, 16, said workpiece holding head likewise being adapted to hold the spectacle lens 11 without the aid of a block piece. Such a workpiece holding head 22 is the subject matter of document WO 2023/073249 A1 which was mentioned at the outset and to which reference is likewise expressly made here with regard to the construction and function of the workpiece holding head 22.

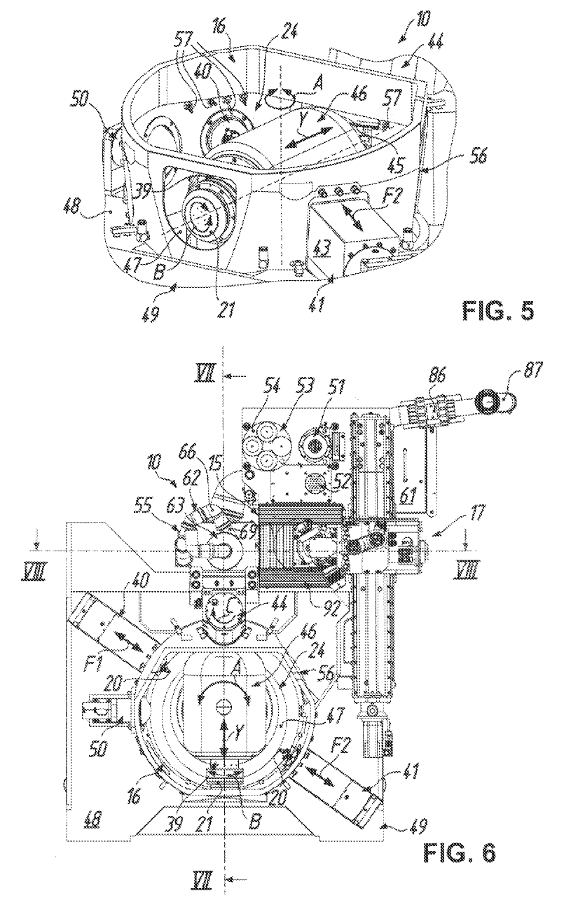

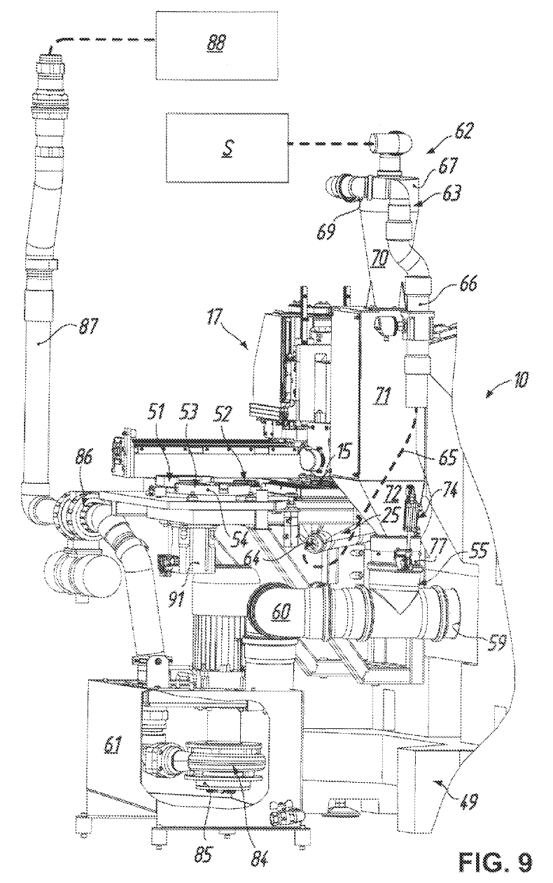

As will be explained in detail below, a special feature of the machine 10 is that the first and second machining stations 15, 16 of the machine 10 have first and second work spaces 23, 24 which are clearly separated from one another and are each encapsulated with respect to the surroundings (see in particular FIGS. 12, 16 and 17 with respect to the first work space 23 and FIGS. 5 and 7 with respect to the second work space 24). Here, the first machining station 15 has a housing 25 which specifically delimits the first work space 23 (cf. FIGS. 9 to 13 and 15 to 17) and is adapted for substantially – see the comments made further above in this regard – dry machining of the spectacle lens 11 at the workpiece edge 14, as will likewise be described in detail below.

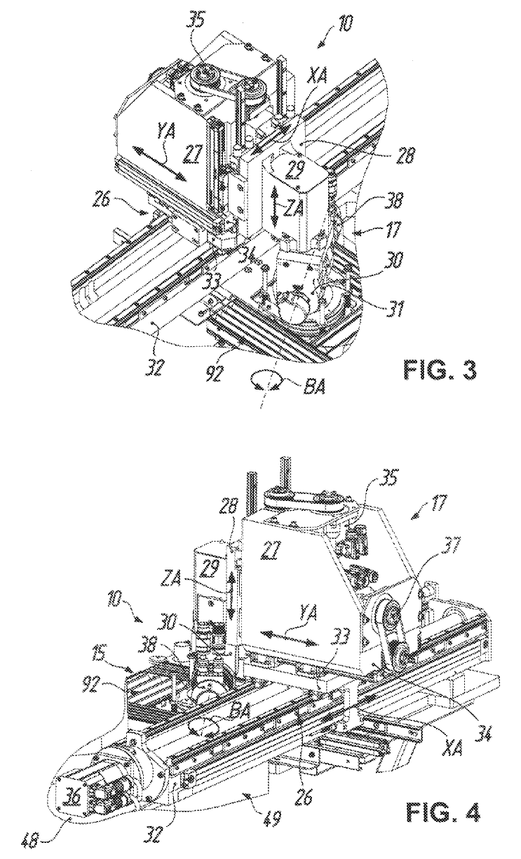

Details of the movement device 17 can be gathered, in particular, from the detailed illustrations according to FIGS. 3 and 4. Accordingly, the movement device 17 is generally adapted to move the workpiece holding head 22 in at least three linear axis directions XA, YA, ZA which are perpendicular to one another, in order to generate the feed and advancing movements required for the edge machining in the first machining station 15, to make transport of the spectacle lens 11 held on the workpiece holding head 22 between the first machining station 15 and the second machining station 16 possible, and to allow a positioned transfer of the spectacle lens 11 to the workpiece receptacle 21 in the second machining station 16. Moreover, the movement device 17 is adapted to pivot the workpiece holding head 22 about at least one pivot axis BA which runs transversely to the axial direction ZA.

More specifically, according to FIGS. 3 and 4, the movement device 17 has a gantry 27 which is guided on a cross-table arrangement 26 and has a vertical carriage 28, to which a console 29 is fastened. A pivot fork 30 for a yoke 31, which carries the workpiece holding head 22, is mounted on the console 29. The cross-table arrangement 26 comprises a base 32, a first horizontal carriage 33 and a second horizontal carriage 34 which is integral with the gantry 27, which horizontal carriages are arranged one above the other. The first horizontal carriage 33 is guided on the base 32 in the axial direction XA via a pair of horizontally running first guide rails and associated carts, while the gantry 27 is guided with the second horizontal carriage 34 on the first horizontal carriage 33 in the axial direction YA via a pair of guide rails, running transversely to the first guide rails and likewise horizontally, and associated carts. On the side of the gantry 27 facing the first and second machining stations 15, 16, the vertical carriage 28 is guided on the gantry 27 in the axial direction ZA via a pair of vertically running guide rails and associated carts.

Each of the carriages 28, 33, 34 is assigned a drive 35, 36, 37, for example in each case a stepping motor with an optionally toothed-belt-driven ball screw drive, by which the respective carriage 28, 33, 34 is linearly displaceable in a position-controlled manner (linear axes XA, YA, ZA). The yoke 31 carrying the workpiece holding head 22 is driven about the pivot axis BA by an angular position-controlled direct drive 38 on the pivot fork 30. The sensor system (rotary encoder, length measuring system, etc.) required in each case for the axial movements (XA, YA, ZA, BA) is shown only partially in the figures and does not require any further explanation for a person skilled in the art.

Details of the second machining station 16 of the machine 10 can be gathered in particular from FIGS. 1, 2 and 5 to 7. Accordingly, the second machining station 16 comprises a workpiece spindle 39, by which the spectacle lens 11 held in a supported manner on the workpiece receptacle 21 can be driven in rotation about a workpiece axis of rotation B. Furthermore, in the exemplary embodiment shown, the second machining station 16 has three machining units for the machining of the spectacle lens 11 held on the workpiece spindle 39 via the workpiece receptacle 21, specifically two turning machining units 40, 41 with in each case one fast-tool servo 42, 43, which serves to generate a linear movement in the direction F1 or F2 for the respectively assigned turning tool 20 as a turning tool, and a milling unit 44 with a tool spindle 45 for generating a rotational movement about a tool axis of rotation C for the milling tool 19.

Moreover, the second machining station 16 has an adjusting mechanism, denoted generally by 46, for generating a relative movement between the workpiece spindle 39 and the respective tool 19, 20 in order (at least) selectively to enable loading/unloading or machining of the spectacle lens 11. Here, the adjusting mechanism 46 comprises a linear drive unit and a pivot drive unit (both not visible in detail in the figures and not shown in section in FIG. 7) which are arranged on top of one another, wherein the workpiece spindle 39 is pivotable by the pivot drive unit about a pivot axis A which is substantially perpendicular to the workpiece axis of rotation B, while the workpiece spindle 39 is movable by the linear drive unit along a linear axis Y which runs substantially perpendicular to the pivot axis A and substantially parallel to the workpiece axis of rotation B.

The adjusting mechanism 46 is arranged in the center of an annular trough-like recess 47 which, starting from an upper side 48, is formed centrally in a machine frame 49 and delimits the second work space 24 of the second machining station 16 of the machine 10 in a downward direction. Around the recess 47, as shown in particular in FIG. 6, proceeding from the upper side 48, a plurality of flange surfaces are recessed into the machine frame 49, said flange surfaces serving for the installation of the machining units 40, 41, 44 in a star-like arrangement around the second work space 24. According to FIGS. 1 and 6, a measuring station 50 for measuring the spectacle lenses 11, in particular for calibrating the machine 10, is also situated directly at the recess 47 in the machine frame 49.

Finally, FIGS. 1, 2 and 6 in particular likewise show, as further constituent parts of the machine 10, the following assemblies:
(a) an imaging station 51 for establishing and determining the location and position of the spectacle lens blank 11 in space;
(b) a further measuring station 52 for measuring the spectacle lens blank 11 held on the workpiece holding head 22 on the front side 12 in order to capture the front-side geometry of the spectacle lens blank 11;
(c) a workpiece store 53 with a rotary carousel 54 for temporarily storing spectacle lens blanks 11; and
(d) a chip discharge device 55, which is explained in more detail below and to which both of the first and second work spaces 23, 24 of the first and second machining stations 15, 16 are connected, on the rear side of the machine 10.

Here, the movement device 17 is able overall to transport spectacle lenses 11 which are machined/are to be machined with their workpiece holding head 22 between the imaging station 51, the measuring station 52, the first machining station 15 and the workpiece receptacle 21 on the workpiece spindle 39 in the second machining station 16 of the machine 10, and to position them spatially in a defined manner at the respective location in accordance with the machining and/or handling requirements respectively existing there. In particular, a defined transfer of the spectacle lens 11, which is unambiguously positioned in space by the movement device 17, from the workpiece holding head 22 on the pivotable yoke 31 of the movement device 17 to the workpiece receptacle 21 on the workpiece spindle 39 can take place in the second work space 24 of the second machining station 16. For this purpose, a selectively closable transfer window (not specifically shown in the figures) is provided at the second machining station 16 in the wall region of the second machining station 16 denoted by the reference sign 56 in FIGS. 5 and 6.

With regard to the further kinematics system of the above-described machine 10 in the region of the second machining station 16, it should also be noted that the workpiece spindle 39 can be moved in a CNC position-controlled manner (A-axis, Y-axis) in a plane running perpendicularly with respect to the pivot axis A by the adjusting mechanism 46 comprising a linear drive unit and a pivot drive unit, while the spectacle lens 11 held on the workpiece receptacle 21 is rotatable about the workpiece axis of rotation B in a CNC position-controlled manner (B-axis) in terms of the angle of rotation. Consequently, the spectacle lens 11 can be moved in the second machining station 16 from one machining unit or station to the next machining unit or station (A-axis), with respect to a machining unit or station transversely thereto (A-axis, possibly combined with Y-axis, in particular for advancing movements) and/or with respect to a machining unit or station in the direction of said machining unit or station or away from said machining unit or station (Y-axis, in particular for infeed movements). Here, on the tool side, the milling tool 19 can be driven rotationally with a controlled rotational speed about the tool axis of rotation C by the tool spindle 45 of the milling unit 44, or the respective turning tool 20 can be fed by the associated fast-tool servo 42, 43 along the respective linear axis F1, F2 in a CNC position-controlled manner and in a reciprocal manner in accordance with the surface shape to be produced on the spectacle lens 11 in order to lift off chips.

Further details of the chip discharge device 55 of the machine 10 can be seen in FIGS. 1, 2 and 5 to 9. As far as the "wet" machining of the rear side 13 of the spectacle lens 11 in the second machining station 16 is initially concerned in this context, i.e. in the second work space 24 of the machine 10, it can be best seen in FIG. 5 that the second work space 24 is equipped with a multiplicity of nozzles 57 at the respective machining units 40, 41, 44, via which nozzles the cooling lubricating liquid is supplied in great quantity during the surface machining of the spectacle lens 11 in order to lubricate and cool at the respective point of engagement between the tool and the workpiece. An introduction of cooling lubricating liquid into the second work space 24 in a quantity of up to 50 liters per minute is not rare here.

As a result of gravity, the cooling lubricating liquid contaminated with the chips and waste pieces from the machining collects in the recess 47 of the machine frame 49. In order to prevent the cooling lubricating liquid from overflowing from the recess 47 into the moving parts of the adjusting mechanism 46 in any case here, an overflow 58 branches off from the recess 47 at a height just below the adjusting mechanism 46 flange-connected to the machine frame 49.

At a lowest point of the recess 47 lying diametrically opposite the overflow 58 with respect to the adjusting mechanism 46, the second work space 24 is provided with an outflow connector 59. Starting from the outflow connector 59 of the second work space 24, an outflow pipe 60 extends with a suitable gradient as far as a collection container 61, shown in FIGS. 1, 2, 6 and 9, of the chip discharge device 55. Accordingly, the chips and waste pieces produced in the second machining station 16 as a result of the surface machining can be flushed out with the cooling lubricating liquid into the collection container 61 via the outflow connector 59 of the second work space 24.

As far as the "substantially dry" machining of the spectacle lenses 11 at the workpiece edge 14 that takes place in the first machining station 15 is concerned, the chip discharge device 55 has a suction system 62. In the exemplary embodiment shown, said suction system 62 comprises a negative pressure source, for example in the form of a commercially available industrial vacuum cleaner S illustrated only schematically in FIG. 9, and a chip separator 63. The chip separator 63 is connected to the housing 25 of the first machining station 15 in order to extract chips from the first work space 23 of the first machining station 15.

For this purpose, the housing 25 of the first machining station 15 has at least one outlet connector 64, as shown for example in FIG. 9, via which the chips can be extracted from the first work space 23 before they reach the chip separator 63 via a flexible hose 65 or channel 66 indicated by a dashed line in FIG. 9.

In the exemplary embodiment shown, the chip separator 63 of the suction system 62 is configured as a cyclone separator, as shown in FIGS. 7 and 8. The cyclone separator comprises an upper part 67, in which a central immersion pipe 68 connected to the negative pressure source S of the suction system 62 opens and which is provided with a circumferential inlet connector 69 connected to the first work space 23 of the first machining station 15 via the above-mentioned connection (hose 65 or channel 66), a conical lower part 70 which adjoins the upper part 67 and merges into an expansion chamber 71, and a chip collector 72 which closes off the expansion chamber 71 in the downward direction.

As can best be seen in FIG. 8, the chip collector 72 of the chip separator 63 has a flap 73 which can be selectively opened by a flap drive 74 in order to empty the chip collector 72. Here, the flap 73 is sealed off from a lower outlet flange 76 of the chip collector 72 by a circumferential seal 75.

As can furthermore be seen from the sectional view according to FIG. 8, a connecting pipe 77 toward the outflow pipe 60 is provided below the outlet flange 76. The connecting pipe 77 has a cut-out, through which a lever extension 78 of the flap 73, which is angled away from the flap 73, projects out of the connecting pipe 77. By way of the lever extension 78, the flap 73 is mounted pivotably about a hinge axis 79 on a hinge which is arranged in the region of the cut-out on the outlet flange 76. Furthermore, a joint 80 is provided on the lever extension 78, on which joint a piston rod 81 of a pneumatic actuator 82 forming the flap drive 74 acts. The side of the pneumatic actuator 82 facing away from the piston rod 81 is articulated on a wall of the chip collector 72 via a further joint 83 for the introduction of force.

It can be seen from the above description that the chip separator 63 of the suction system 62 can be connected to the collection container 61. Specifically, the chip collector 72 of the chip separator 63 can be emptied into the outflow pipe 60 between the outflow connector 59 of the second work space 24 and the collection container 61 of the chip discharge device 55, by the flap 73 being opened by the flap drive 74.

As FIG. 9 furthermore shows in the region of the partial section in the collection container 61 of the chip discharge device 55, a shredder pump 84 is arranged in the collection container 61, the pump head 85 of which shredder pump is equipped with a cutting mechanism (not shown in greater detail) for shredding the chips. The shredder pump 84 in the collection container 61 can be connected via an automatically switchable valve 86 to a conveying line 87 for contaminated cooling lubricating liquid. This conveying line 87 finally ends in a conventional treatment system 88 for contaminated cooling lubricating liquid, which is shown only schematically in FIG. 9.

Further details of the first machining station 15 can be gathered from FIGS. 10 to 21. As already mentioned further above, the first machining station 15 is configured with a geometrically determined cutting edge for substantially dry machining of the spectacle lens 11 for shaping the workpiece edge 14 by the first tool 18 (end mill). For this purpose, the housing 25 of the first machining station 15 according to FIG. 16 has an opening 90 which is surrounded by a flange portion 89 and through which a spindle 91 of the first machining station 15, which spindle is flange-connected to the flange portion 89 and has a rotationally drivable tool receptacle for the first tool 18, projects into the first work space 23. By the spindle 91, the first tool 18 can be driven in rotation in a controlled manner in terms of rotational speed about a further tool axis of rotation D.

This machining unit (milling spindle 91 with end mill 18 of the first machining station 15) serves to form a circumferential groove, step or a circumferential recess in the front side 12 in a substantially dry manner on the spectacle lens blank 11 by the end mill 18, before the machining of the rear side 13 of the spectacle lens 11 held there on the workpiece receptacle 21 begins later in the second machining station 16. This procedure for cribbing or finished edging in the machining of spectacle lenses 11 is described in detail in the document WO 2023/046937 A1 which is already discussed at the outset and to which reference is expressly made at this point with regard to the method details.

The housing 25 of the first machining station 15 is furthermore covered on a side lying opposite the first tool 18 with a work space cover 92, by which the first work space 23 can be separated from the surroundings, as can best be seen in FIGS. 10 to 12 and 16. As can likewise be seen from FIGS. 12 and 16, the work space cover 92 on the housing 25 of the first machining station 15 is of variable design and has, for coupling the workpiece holding head 22, an interface 93 which is movable with respect to the first work space 23 and has an open coupling part 94. A spectacle lens 11 held on the workpiece holding head 22 can be inserted through the coupling part 94 into the first work space 23 in order to come into machining engagement with the first tool 18, as shown in FIG. 16.

FIGS. 12 and 16 furthermore show that the coupling part 94 of the interface 93 has a conically shaped inner circumferential surface 95, while the workpiece holding head 22 has a flange portion 96 which, on the outer circumferential side, is of conical form complementary to the conically shaped inner circumferential surface 95 of the coupling part 94, such that, when the workpiece holding head 22 is coupled to the interface 93, self-centering takes place between the coupling part 94 and the flange portion 96.

As indicated by movement arrows in FIGS. 10 to 16 and 20, the coupling part 94 of the interface 93 is arranged movably with respect to the first work space 23 in a plane formed by a first direction R1 and a second direction R2 running transversely thereto on the variable work space cover 92 and a third direction R3 running transversely to this plane. Here, a guide arrangement 97 ensures that the coupling part 94 of the interface 93 is guided during a movement in the third direction R3, wherein the coupling part 94 is spring-preloaded in the third direction R3 away from the first work space 23 by a spring arrangement 98.

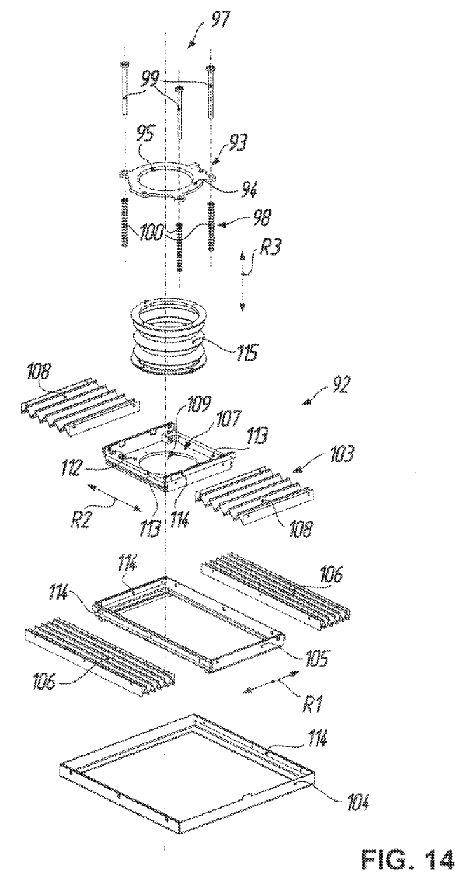

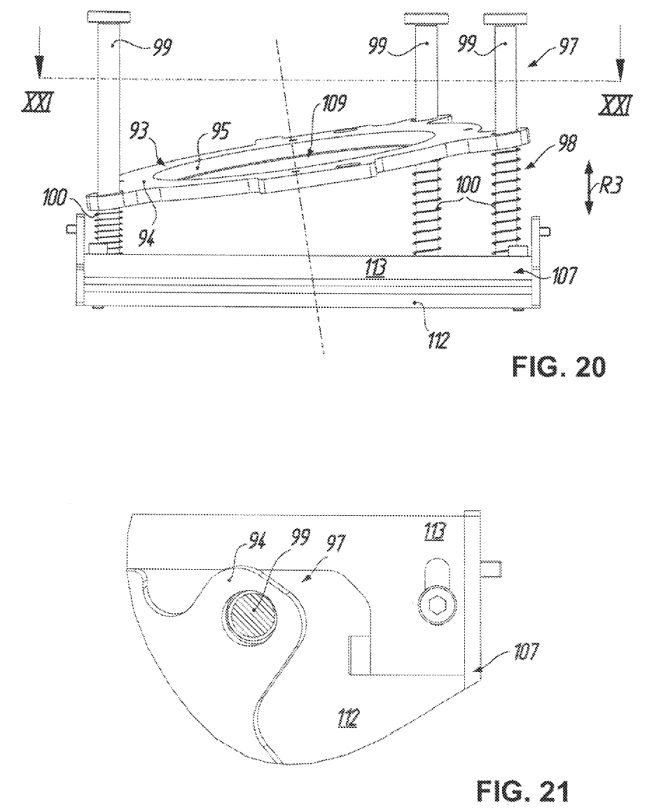

In the exemplary embodiment shown, the guide arrangement 97 has three guide rods 99, as can be seen in FIGS. 14 and 20, on each of which a helical compression spring 100 of the spring arrangement 98 is received. Here, the arrangement is such that the coupling part 94 of the interface 93 is also guided on the guide arrangement 97 in a tiltable manner with respect to the plane formed by the first and second directions R1, R2, as shown in FIG. 20. For this purpose, according to FIG. 21, the guide bores in the coupling part 94 are formed with an inner diameter which is larger than the outer diameter of the guide rods 99. The play created in this way makes it possible to tilt the coupling part 94 for prismatic machining of spectacle lenses 11 without influencing the guidance in an interfering manner in the process.

According to in particular FIGS. 10 to 12, the variable work space cover 92 furthermore has a fixing device 101 for the coupling part 94 of the interface 93, having at least one, in the exemplary embodiment shown two – here, tab-shaped – locking elements 102 which can be selectively moved from a fixing position for the coupling part 94 (FIGS. 10 and 12) into a release position for the coupling part 94 (FIG. 11), and vice versa. Here, the locking elements 102 are adapted to hold the coupling part 94 in their fixing position in a defined parking position, in which the spring arrangement 98 preloading the coupling part 94 is compressed, and to be disengaged from the coupling part 94 in their release position, such that the coupling part 94 can be moved in a guided manner on the guide arrangement 97 in working positions under preload by the spring arrangement 98. In the exemplary embodiment shown, screws on the locking elements 102 serve to hold the fixing position, the heads of which screws can come into engagement with associated bores in the coupling part, as shown in FIG. 12.

According to in particular FIGS. 10 to 12 and 14, the variable work space cover 92 furthermore has a bellows arrangement 103, comprising an outer frame 104 which is fixedly connected (cf. FIG. 12) to the housing 25 of the first machining station 15, a middle frame 105 which is guided in the outer frame 104 so as to be slidable in the first direction R1 and which is connected to the outer frame 104 on sides lying opposite one another in the first direction R1 via in each case one flat bellows 106, and an inner frame 107 which is guided in the middle frame 105 so as to be slidable in the second direction R2 running transversely with respect to the first direction R1 and which is connected to the middle frame 105 on sides lying opposite one another in the second direction R2 via in each case one flat bellows 108. Here, the inner frame 107 is provided with an opening 109 for the workpiece holding head 22 to pass through into the first work space 23, and carries the interface 93 for the workpiece holding head 22.

To be more precise, the outer frame 104 and the middle frame 105 are each produced from a single-piece metal sheet and have a rectangular base portion which extends in the horizontal direction, that is to say in a plane formed by the directions R1 and R2, and the edges of which running parallel to the first and second directions R1, R2 are adjoined by edge portions which extend in the vertical direction R3 and are formed by upward edges. In order to allow passage from above into the first work space 23, the base portion of the respective frame 104, 105 has a central cut-out.

Below the regions of the middle frame 105 which run in the first direction R1, sliding discs 110 are arranged, via which the middle frame 105 rests in a sliding manner on the base portion of the outer frame 104. For protection against lifting of the middle frame 105 from the outer frame 104 and for guiding the middle frame 105 in the outer frame 104, two guide strips 111 with an L-shaped guide contour are provided below the middle frame 105, which are oriented with a certain amount of play with respect to the edges of the recess in the outer frame 104 and engage behind the outer frame 104 through the cut-out.

The inner frame 107 comprises a rectangular covering plate 112 which likewise lies in the horizontal plane and in which the opening 109 for the workpiece holding head 22 to pass through is formed centrally. Screwed onto the upper side of the covering plate 112, on the sides parallel to the direction R2, is in each case a guide rail 113 made of a slidable material with a groove, which is designed such that the inner frame 107 is guided by the groove on the base portion of the middle frame 105 along the cut-out in the middle frame 105 in the second direction R2. Finally, clamping strips 114 are provided for the clamping fastening of the flat bellows 106, 108 sealing the frames 104, 105, 107 against one another, as can be seen from the sectional illustrations according to FIGS. 12, 18 and 19.

Moreover, the bellows arrangement 103 has a substantially hollow-cylindrical bellows 115 which is arranged between the coupling part 94 of the interface 93 and the inner frame 107 in a manner which seals the first work space 23 with respect to the surroundings, as shown in FIG. 12.

With respect to the housing 25 of the first machining station 15, which housing is expediently injection-molded or produced by additive manufacturing, from a plastic with optionally electrically conductive, antistatic or statically dissipating properties, it should finally also be said that, as can be clearly seen in FIG. 16, the housing 25 has at least one inlet connector 116, via which ambient air, in particular, can be passively sucked into or actively supplied to the first work space 23. Furthermore, at least one, in the exemplary embodiment shown two, nozzles 117 for compressed air is/are attached to the housing 25, which nozzles are fixedly directed or can be variably directed onto the first tool 18 for the substantially dry cutting shaping of the workpiece edge 14, in order to blow out and cool a cutting point between the workpiece 11 and the first tool 18. These nozzles 117 are shown in FIGS. 16 and 17.

Overall, the housing 25 of the first machining station 15 is designed in a flow-optimized manner with regard to an unimpeded discharge of chips, without undercuts and without corners in the first work space 23. Here, the housing 25 is expediently of smoothed design on its surfaces 118 delimiting the first work space 23.

A machine for machining, in particular, spectacle lenses made of plastic, with two workpiece surfaces and a workpiece edge therebetween, comprises a first machining station for machining a spectacle lens at the workpiece edge by a first tool, a second machining station for wet machining of the spectacle lens on one of the workpiece surfaces by a second tool, and a movement device, arranged functionally between the machining stations, for positioning a workpiece holding head at the respective machining station, which is able to hold the workpiece without a block piece. Here, the machining stations have first and second work spaces which are separate from one another and are each encapsulated with respect to the surroundings. The first machining station furthermore has a housing which specifically delimits the first work space, and is adapted for substantially dry machining of the workpiece at the workpiece edge.

Other variations and modifications are possible without departing from the scope and spirit of the present invention as defined by the appended claims.

We claim:

1. A machine for machining optical workpieces made of plastic, in particular spectacle lenses, which each have two workpiece surfaces and a workpiece edge therebetween, comprising
at least one first machining station which is configured for machining a workpiece for shaping the workpiece edge by at least one first tool with a geometrically defined cutting edge,
at least one second machining station which is designed for wet machining of the workpiece for shaping at least one of the workpiece surfaces by at least one second tool with a geometrically defined cutting edge while supplying a cooling lubricating liquid, and
a movement device arranged functionally between the at least one first machining station and the at least one second machining station for positioning a workpiece holding head at the respective first or second machining station, which movement device is adapted to hold the workpiece without a block piece,
characterized in that the first and second machining stations of the machine have first and second work spaces which are separate from one another and are each encapsulated with respect to the surroundings, wherein the first machining station has a housing, which specifically delimits the first work space, and is constructed for substantially dry machining of the workpiece at the workpiece edge.

2. A machine according to claim 1, characterized in that the housing of the first machining station is covered, on a side lying opposite the first tool, by way of a variable work space cover, by which the first work space can be separated from the surroundings.

3. A machine according to claim 2, characterized in that, for coupling the workpiece holding head, the variable work space cover has, on the housing of the first machining station, an interface which is movable with respect to the first work space and has an open coupling part, through which a workpiece held on the workpiece holding head can be introduced into the first work space in order to come into machining engagement with the first tool.

4. A machine according to claim 3, characterized
in that the coupling part of the interface is arranged movably with respect to the first work space in a plane formed on the variable work space cover by a first direction and a second direction running transversely thereto, as well as a third direction running transversely to this plane; and/or
in that the coupling part of the interface has a conically shaped inner circumferential surface, while the workpiece holding head has a flange portion which, on the outer circumferential side, is of conical form complementary to the conically shaped inner circumferential surface of the coupling part, such that, when the workpiece holding head is coupled to the interface, self-centering takes place between the coupling part and the flange portion.

5. A machine according to claim 4, characterized in that the coupling part of the interface is guided by a guide arrangement during a movement in the third direction, wherein the coupling part is spring-preloaded in the third direction away from the first work space by a spring arrangement.

6. A machine according to claim 5, characterized in that
the coupling part of the interface is guided on the guide arrangement so as to be tiltable with respect to the plane formed by the first and second directions (R1, R2); and/or
in that the variable work space cover has a fixing device for the coupling part of the interface, comprising at least one locking element which is selectively movable from a fixing position for the coupling part into a release position for the coupling part and vice versa, wherein the locking element is adapted, in its fixing position, to hold the coupling part in a defined parking position, in which the spring arrangement preloading the coupling part is compressed, and to be disengaged from the coupling part in its release position, such that the coupling part can be moved in a guided manner on the guide arrangement into working positions under preload by the spring arrangement.

7. A machine according to claim 6, characterized in that the variable work space cover has a bellows arrangement, comprising an outer frame fixedly connected to the housing of the first machining station, a middle frame which is slidably guided in the outer frame in the first direction, and is connected to the outer frame on opposite sides in the first direction via in each case one flat bellows, and an inner frame which is slidably guided in the middle frame in the second direction, running transversely with respect to the first direction, and is connected to the middle frame via in each case one flat bellows on opposite sides in the second direction, wherein the inner frame is provided with an opening for the workpiece holding head to pass through into the first work space, and carries the interface for the workpiece holding head.

8. A machine according to claim 7, characterized in that the bellows arrangement has, furthermore, a substantially hollow-cylindrical bellows which is arranged between the coupling part of the interface and the inner frame in a manner which seals the first work space with respect to the surroundings.

9. A machine according to claim 8, characterized
in that the housing of the first machining station has at least one outlet connector, via which, in particular, chips can be extracted from the first work space; and/or
in that the housing of the first machining station has at least one inlet connector, via which, in particular, ambient air can be passively sucked or actively supplied into the first work space; and/or
in that the housing of the first machining station has at least one opening which is surrounded by a flange portion and through which a spindle of the first machining station, which spindle is flange-connected to the flange portion, projects into the first work space with a rotationally drivable tool holder for the first tool; and/or
in that at least one nozzle for compressed air is attached to the housing of the first machining station, said nozzle being fixedly directed or variably directable onto the first tool for the substantially dry cutting shaping of the workpiece edge, in order to blow out and cool a cutting point between the workpiece and the first tool; and/or
in that the housing of the first machining station is designed to be optimized in terms of flow with regard to an unimpeded discharge of chips, without undercuts and without corners in the first work space; and/or
in that the housing of the first machining station is of smoothed form on its surfaces delimiting the first work space; and/or
in that the housing of the first machining station is injection-molded or produced by additive manufacturing, from a plastic with optionally electrically conductive, antistatic or statically dissipating properties.

10. A machine according to claim 9, characterized by a chip discharge device, to which one or preferably both of the first and second work spaces of the first and second machining stations is/are connected.

11. A machine according to claim 10, characterized
in that the chip discharge device comprises a suction system with a chip separator, which is connected to the housing of the first machining station in order to extract chips from the first work space; and/or
in that the chip discharge device comprises a collection container, into which chips can be flushed out with the cooling lubricating liquid via an outflow connector of the second work space.

12. A machine according to claim 11, characterized
in that the chip separator of the suction system is connectable to the collection container; and/or
in that the chip separator of the suction system is configured as a cyclone separator, having an upper part, into which a central immersion pipe which can be connected to a negative pressure source of the suction system opens and which is provided with a circumferential-side inlet connector connected to the first work space, having a conical lower part which adjoins the upper part and merges into an expansion chamber, and having a chip collector which closes off the expansion chamber in the downward direction; and/or
in that a shredder pump, the pump head of which is equipped with a cutting mechanism for shredding the chips, is arranged in the collection container of the chip discharge device.

13. A machine according to claim 12, characterized
in that the chip collector of the chip separator has a flap which can be selectively opened by a flap drive in order to empty the chip collector, wherein the flap is preferably sealed off from a lower outlet flange of the chip collector by a circumferential seal; and/or
in that the chip collector of the chip separator can be emptied into an outflow pipe between the outflow connector of the second work space and the collection container of the chip discharge device; and/or
in that the shredder pump in the collection container can be connected to a conveying line for contaminated cooling lubricating liquid via a valve which can be switched in an automated manner.

14. A machine according to claim 13, characterized in that the movement device is adapted to move the workpiece holding head in at least three linear, mutually perpendicular axial directions in order to generate the feed and advancing movements required for edge machining in the first machining station, to make transport of the workpiece held on the workpiece holding head between the first machining station and the second machining station possible and, in the second machining station, to permit a positioned transfer of the workpiece.

15. A machine according to claim 14, characterized in that the movement device is additionally adapted to pivot the workpiece holding head about at least one pivot axis (BA) which runs transversely to one axial direction of the axial directions.

16. A machine according to claim 1, characterized
in that the housing of the first machining station has at least one outlet connector, via which, in particular, chips can be extracted from the first work space; and/or
in that the housing of the first machining station has at least one inlet connector, via which, in particular, ambient air can be passively sucked or actively supplied into the first work space; and/or
in that the housing of the first machining station has at least one opening which is surrounded by a flange portion and through which a spindle of the first machining station, which spindle is flange-connected to the flange portion, projects into the first work space with a rotationally drivable tool holder for the first tool; and/or
in that at least one nozzle for compressed air is attached to the housing of the first machining station, said nozzle being fixedly directed or variably directable onto the first tool for the substantially dry cutting shaping of the workpiece edge, in order to blow out and cool a cutting point between the workpiece and the first tool; and/or
in that the housing of the first machining station is designed to be optimized in terms of flow with regard to an unimpeded discharge of chips, without undercuts and without corners in the first work space; and/or
in that the housing of the first machining station is of smoothed form on its surfaces delimiting the first work space; and/or
in that the housing of the first machining station is injection-molded or produced by additive manufacturing, from a plastic with optionally electrically conductive, antistatic or statically dissipating properties.

17. A machine according to claim 1, characterized in that the movement device is adapted to move the workpiece holding head in at least three linear, mutually perpendicular axial directions in order to generate the feed and advancing movements required for edge machining in the first machining station, to make transport of the workpiece held on the workpiece holding head between the first machining station and the second machining station possible and, in the second machining station, to permit a positioned transfer of the workpiece.
